(19) United States
(12) Patent Application Publication
(10) Pub. No.: US 2002/0131728 A1
(43) Pub. Date: Sep. 19, 2002

(54) Method and apparatus to optimize optical coupling in an axis orthogonal to the optical axis

(76) Inventor: Joseph S. Kovalchick, Germansville, PA (US)

Correspondence Address: JONES VOLENTINE, P.L.L.C., SUITE 150, 12200 SUNRISE VALLEY DRIVE, RESTON, VA, 20191, US

(21) Appl. No.: 09/943,083

(22) Filed: Aug. 31, 2001

Related U.S. Application Data
(60) Provisional application No. 60/276,133, filed on Mar. 16, 2001.

(51) Int. Cl. G02B 6/42

(52) U.S. Cl. 385/90; 385/93; 385/67

(57) ABSTRACT

An optical subsystem includes a passive optical element having a lens element eccentric therein. The passive optical element is provided adjacent to an optical element on a submount and orthogonal to the submount. The alignment of the passive optical element and the optical element on the submount may be realized by rotating the passive optical element. The alignment may be further enhanced by translating the passive optical element and the optical element on the submount relative to one another. Once desired alignment is achieved, the passive optical element is secured to the submount.

### CROSS REFERENCE TO RELATED APPLICATIONS

The present application claims priority under 35 U.S.C. §119(e) to U.S. Provisional Application No. 60/276,133 entitled “Method and Apparatus to Optimize Optical Coupling in an Axis Orthogonal to the Optical Axis” filed Mar. 16, 2001, which is hereby incorporated by reference in its entirety for all purposes

### FIELD OF THE INVENTION

The present invention relates generally to optical assemblies and subassemblies, and particularly to a device which fosters precision alignment of an optical device to another optical device.

### BACKGROUND OF THE INVENTION

When aligning an active optical element and a passive optical element, manufacturing tolerances often add to the axial misalignment between the passive and active optical elements. Previous attempts to correct for this axial misalignment include use of multiple piece parts, active alignment and/or compromised optical designs attempting to mitigate y-axis alignment problems.

### SUMMARY OF THE INVENTION

The present invention relates to an optical coupling alignment method and apparatus which overcomes at least one of the above disadvantages.

It is an object of the present invention to substantially precisely align optical axes of devices.

To achieve this and other objects, according to an exemplary embodiment of the present invention, a coupling device is disposed in an alignment slot to locate a passive optical element which has an optical axis and an outside diameter that are not concentric.

At least one of the above and other objects may be realized by providing a method for aligning an optical element on a substrate with a passive optical element orthogonal to the substrate including providing a lens element in the passive optical element which is eccentric in the passive optical element, rotating the passive optical element until optical coupling between the lens element and the optical element is optimized, and securing the lens element in an optimized position.

At least one of the above and other objects may be realized by providing an optical subsystem including an optical element on a submount, a passive optical element including a lens element eccentric therein, the passive optical element being provided adjacent to the optical element and orthogonal to the submount, and a securing mechanism which maintains an optimized position of the lens element and the optical element

These and other objects of the present invention will become more readily apparent from the detailed description given hereinafter. However, it should be understood that the detailed description and specific examples, while indicating the preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention is best understood from the following detailed description when read with the accompanying drawing figures. It is emphasized that the various features are not necessarily drawn to scale. In fact, the dimensions may be arbitrarily increased or decreased for clarity of discussion.

FIG. 1(a) is an elevational perspective view of a submount assembly including a passive optical element according to an illustrative embodiment of the present invention.

FIG. 1(b) is a perspective top view of a submount assembly including a passive optical element according to an illustrative embodiment of the present invention.

FIG. 1(c) is a side view of a submount assembly including a passive optical element according to an illustrative embodiment of the present invention.

FIG. 2(a) is a perspective view of a passive optical element according to an illustrative embodiment of the present invention.

FIG. 2(b) is a side view of a passive optical element according to an illustrative embodiment of the present invention.

FIG. 2(c) is a front view of a passive optical element according to an illustrative embodiment of the present invention.

FIG. 3(a) is a front view of a passive optical element according to an illustrative embodiment of the present invention.

FIG. 3(b) is a perspective view of the passive optical element shown in FIG. 3(a) mounted on a substrate

FIG. 4(a) is an exploded perspective view of a passive optical element according to another illustrative embodiment of the present invention.

FIG. 4(b) is an assembled perspective view of a passive optical element according to another illustrative embodiment of the present invention

### DETAILED DESCRIPTION

In the following detailed description, for purposes of explanation and not limitation, exemplary embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known devices, methods and materials may be omitted so as to not obscure the description of the present invention.

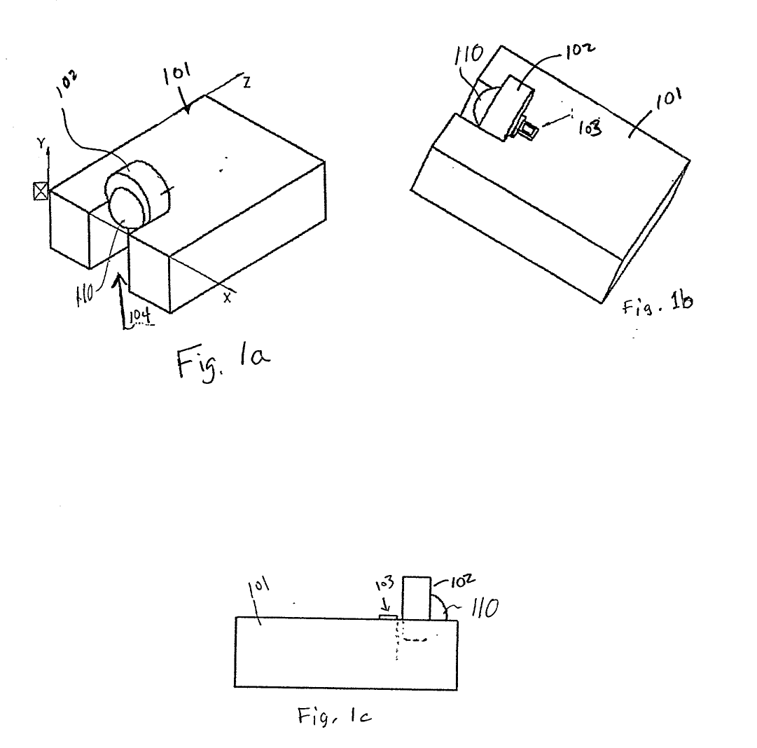

Turning to FIG. 1(a), a perspective view according to an exemplary embodiment of the present invention is shown. A submount 101 has a passive optical element 102 disposed in a slot 104. As shown in FIG. 1(b), the passive optical element 102 couples optically to another optical element 103. In the illustrative embodiment shown in FIG. 1(b), optical element 103 is an active optical device. Optical element 103 may be a light emitting device, such as a laser. Of course, optical element 103 could be an optical detector, such as a PIN detector. Moreover, optical element 103 could be passive optical devices such as a refractive or diffractive optical element. Finally, while not shown in the illustrative embodiment of FIG. 1(b), a passive optical device (e.g. an optical waveguide) could also be disposed over the submount 101, and could optically couple to the passive optical element 103.

As shown in FIG. 1(a)-1(c), the passive optical element 102 includes a lens portion 110 having power, i.e., shapes the beam by other than due to the change in refractive index at the interfaces of the passive optical element 102. According to the illustrative embodiment shown in FIGS. 1(a)-1(c), the properties of eccentricity are used in the fabrication of the passive optical element 102. As used herein, eccentricity does not refer to the lens properties themselves, but to the position of the lens portion 110 having power in the overall passive optical element 102. The incorporation of the eccentricity into the passive optical element 102 fosters precise alignment of the optic axes of optical devices. To this end, the optic axes of the passive optical element and that of the active optical device may be precisely aligned. Moreover, this fosters precise optical alignment to another optical device, such as an optical fiber or other waveguide (not shown), which may then be coupled to the active optical element 103 by way of the passive optical device 102. If the active optical element 103 is a detector, typically the lens portion 110 would face the detector.

In the illustrative embodiment shown in FIGS. 1(a)-1(c), the passive optical device is a lens element. The alignment slot 104 is used to position the passive optical element 102. The passive optical element 102 has been fabricated such that the optical axis of the lens portion 110 and outside diameter of the passive optical element 102 are not concentric. As a function of the rotation of the passive optical element 102 about its outside diameter, the optical axis of the lens portion 110 may be positioned in the Y-axis to match the “Y” optical axis of optical element 103. In the event that optical element 103 is an active device, the height of the active area of the active device could be measured with respect to the surface of the lens to which it is bonded. The passive optical element 102 would then be rotated such that the optical centerline of the lens element 110 would be matched to the height of an active region of the optical element 103, i.e., so that light may be coupled between the optical elements. In other words, this rotation is not to alter the functioning of the passive optical element 102, but to have the same functioning regardless of the position of the optical element 103 along the Y-axis within some predetermined range.

As can be readily appreciated, the rotation of the passive optical element 102 in the alignment slot 104 compensates for variation in Y-axis alignment between the passive optical element 102 and the active optical element 103. However, when the lens 110 is rotated to adjust the Y-axis alignment, there is also a translation in the X-axis. In other words, as the lens is rotate, there is a translation of the lens in both the Y (Vertical) and X (Horizontal) axes. The X-axis translation may be taken into account. In the embodiment depicted in FIGS. 1(a)-1(c), the optical device 103 would need to be bonded at an offset in the X-axis as a function of the translation caused by the phase angle of 102. Alternatively, the passive optical element 102 could be offset in the X-axis.

Alignment of the passive optical element 102 and the optical device 103 may be done in a number of ways, e.g., machine vision. A system could be constructed that has cameras looking down the appropriated axes, either manually or automatically. Alternatively, active alignment could be used. When the elements 102, 103 are satisfactorily aligned, they are secured in position in a conventional manner. Once the desired alignment is obtained, the passive optical element may be secured to the submount in any conventional manner.

Tuning to FIGS. 2(a)-2(c), a variety of views of the passive optical element 102 are shown. According to the illustrative embodiment of FIG. 2(b), the passive optical element 102 includes a lens element 110. The eccentricity of the lens element 110 is shown in front view in FIG. 2(c). As can be seen, the outside circle 202 in FIG. 2(c) is not concentric with the optic axis of the lens element 110. The eccentricity, i.e., the difference between the center of the outer circle 202 and the optical axis of the lens element 110, is indicated at e in FIG. 2(c). The eccentricity is the delta between the centerline of the optical axis 110 and the outside diameter of 102. Increasing this delta provides a greater range of adjustment. The degree of adjustment that is possible according to the illustrative embodiment of the present disclosure is approximately two times the amount of the eccentricity of the passive optical element 102. The round outside diameter provides continuous height adjustment within a defined range.

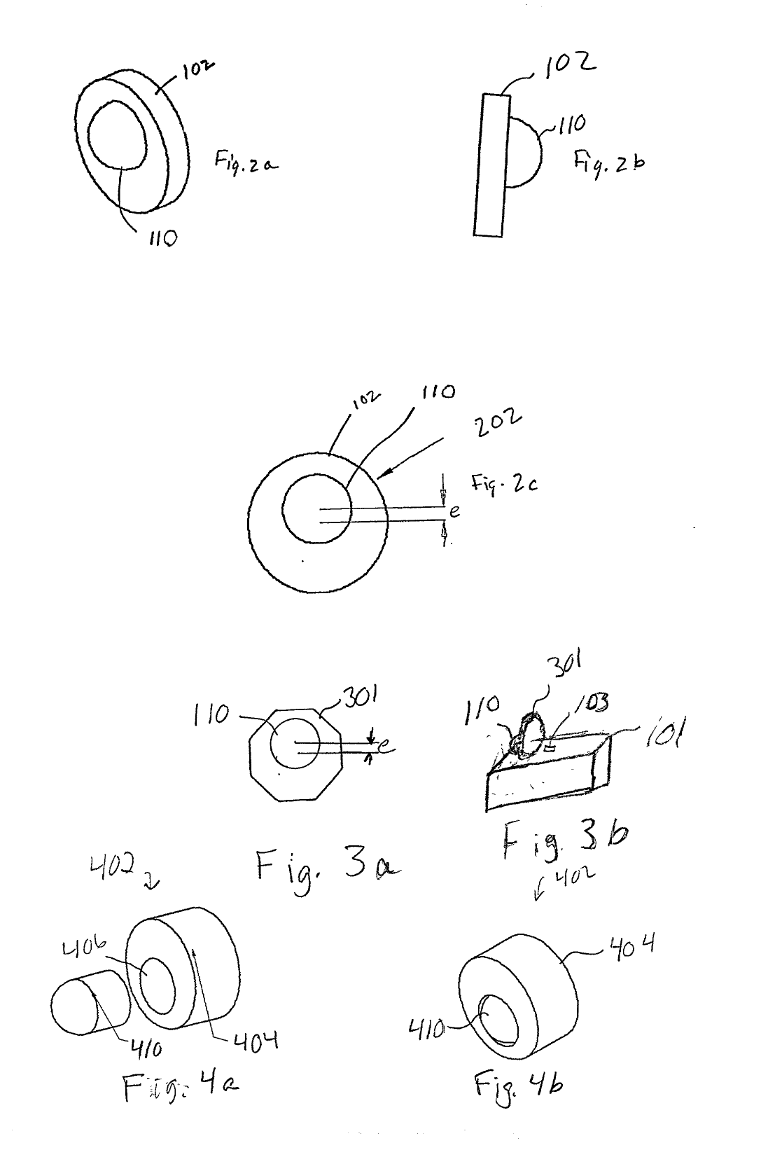

While the passive optical element 102 in the above illustrative embodiments is substantially cylindrical, other shapes could be incorporated to provide discrete adjustments in y-axis alignment. One such example may be a polygonal element 301, shown in FIG. 3(a). Here, the lens element 110 is still not aligned with the center of the polygonal element 301 and the eccentricity e allows for discrete alterations to the y-axis alignment. Of course, the more surfaces in the polygon, i.e., the more the polygon approximates a circle, the more continuous the rotation of the polygonal element 301 becomes. In the event that the polygonal element 301 is used, it could be attached to a flat surface, for example a surface of the submount 101, thus eliminating the need for the alignment slot 104 of FIGS. 1(a)-1(b). Such attachment is shown in FIG. 3(b), in which the polygonal passive optical element 301 is mounted on the same surface of the submount 101 as the optical element 103.

Either passive optical element including lens element 110 could be manufactured with standard processes, such as grinding/polishing and molding. The passive optical elements including lens element 110 may be fabricated from known materials, such as Corning BCD C2060 or Schott SK16.

The passive optical element shown in the previous embodiments was an integral passive optical element. According to another illustrative embodiment shown in FIGS. 4(a) and 4(b), a passive optical element 402 includes a lens element 410 placed eccentrically in a hole or other receptacle 406 in a housing 404 or in an eccentric housing. The housing 404 and the lens element 410 could now be made of different materials.

It will be obvious that the invention may be varied in a plurality of ways. For example, the alignment slot does not have to be through the substrate, but may extend underneath the passive optical element to provide support thereto. Such variations are not to be regarded as a departure from the scope of the invention. All such modifications as would be obvious to one skilled in the art are intended to be included within the scope of the appended claims.

What is claimed is:

1. A method for aligning an optical element on a substrate with a passive optical element orthogonal to the substrate, the method comprising:
providing a lens element in the passive optical element which is eccentric in the passive optical element;
rotating the passive optical element until optical coupling between the lens element and the optical element is optimized; and
securing the lens element in an optimized position.

2. The method according to claim 1, further comprising, after said rotating, translating the passive optical element and the optical element on the substrate relative to one another until the optical coupling between the lens element and the optical element is optimized.

3. The method according to claim 2, wherein said translating include translating the optical element on the substrate and further comprising securing the optical element in an optimized position.

4. The method according to claim 1, wherein said rotating is continuous.

5. The method according to claim 1, wherein said rotating is discrete.

6. The method according to claim 1, further providing an alignment slot receiving the passive optical element in the substrate.

7. The method according to claim 6, wherein said providing includes forming an alignment slot through the substrate.

8. The method according to claim 1, further mounting the passive optical element on a same surface of the substrate as the optical element on the substrate.

9. The method according to claim 1, wherein said providing the lens element includes forming an integral element.

10. The method according to claim 1, said providing the lens element includes eccentrically securing the lens element to a housing.

11. The method according to claim 10, wherein said securing includes placing the lens element in a receptacle in the housing.

12. An optical subsystem comprising:
an optical element on a submount;
a passive optical element including a lens element eccentric therein, the passive optical element being provided adjacent to the optical element and orthogonal to the submount; and
a securing mechanism which maintains an optimized position of the lens element and the optical element.

13. The optical subsystem according to claim 12, wherein the optical element is an active optical element.

14. The optical subsystem according to claim 12, further comprising an alignment slot is in the submount which receives the passive optical element.

15. The optical subsystem according to claim 14, wherein the alignment slot is through the submount.

16. The optical subsystem according to claim 12, wherein the passive optical element is provided on a same surface of the submount as the optical element.

17. The optical subsystem according to claim 12, wherein the passive optical element is circular.

18. The optical subsystem according to claim 12, wherein the passive optical element is polygonal.

19. The optical subsystem according to claim 12, wherein the optimized position is obtained by rotating the passive optical element.

20. The optical subsystem according to claim 19, wherein the optimized position is further obtained by translating the passive optical element and the optical element on the submount relative to one another.

19. The optical subsystem according to claim 18, wherein the optical element is translated.

20. The optical subsystem according to claim 12, wherein the lens element is integral with the passive optical element.

21. The optical subsystem according to claim 12, wherein the passive optical element includes the lens element eccentrically secured to a housing.

22. The method according to claim 21, wherein the housing has a receptacle which receives the lens element.
